(19) United States
(12) Patent Application Publication
(10) Pub. No.: US 2016/0107878 A1
(43) Pub. Date: Apr. 21, 2016

(54) INTERCHANGEABLE EQUINE SADDLE PAD COVER ASSEMBLY AND METHOD

(71) Applicant: Show Skinz, L.L.C., Croydon, UT (US)

(72) Inventor: Nacon Wilde, Croydon, UT (US)

(73) Assignee: Show Skinz, L.L.C., Croydon, UT (US)

(21) Appl. No.: 14/884,334

(22) Filed: Oct. 15, 2015

Related U.S. Application Data
(60) Provisional application No. 62/064,390, filed on Oct. 15, 2014.

(51) Int. Cl. B68C 1/12

(52) U.S. Cl. CPC B68C 1/12

(57) ABSTRACT

An equine saddle pad assembly is disclosed that includes a saddle pad and a saddle pad cover for changing the appearance of a saddle pad to match or coordinate with horse riding accessories or the outfit of a horse rider. A method for changing an appearance of a saddle pad is also disclosed.

### PRIORITY

The present application claims the benefit under 35 U.S.C. §119(e) of U.S. Provisional Patent Application Ser. No. 62/064,390 filed on Oct. 15, 2014, which is incorporated herein by reference in its entirety.

### THE FIELD OF THE INVENTION

The present application relates to a novel equine saddle pad cover assembly and a novel method for changing the appearance of a saddle pad using a novel saddle pad cover and assembly. More particularly, the present application relates to an interchangeable saddle pad cover assembly and method thereof used for quickly changing the saddle pad appearance without inferring with the function of the saddle pad or the performance of the horse.

### BACKGROUND

Horses are trained and ridden for use in work, competitive sports, non-competitive recreational riding, traditional ceremonies, and transportation. Saddles are often used in horseback riding as a support structure for the rider or other load. Two examples of saddles include Western saddles and English saddles. Western saddles are larger and heavier and are adapted to distribute weight of the rider and load over the back of the horse. English saddles are as light as possible to help the horse jump and gallop.

A saddle pad is commonly used to avoid friction between the horse and the saddle and to provide a comfortable fit for the horse. In addition to reducing friction, use of a saddle pad can improve air circulation, absorb sweat, cushion the saddle, relieve pressure points, absorb shock, keep sweat and dirt off a saddle, and help protect from compression. Types of saddle pads may include full pads, square pads, dressage pads, shaped pads, half pads, riser pads, Western pads, and English pads. Some horses may require specialized saddle pads to address special needs of a horse, such as back muscling and allergies.

In the horseback riding community, one of the ways to show individuality and style is by the color and style of the saddle pad. For special events, it may be desirable to match or coordinate a saddle pad with the color of a horse, accessories, or outfit of the horse rider. However, it can be cost prohibitive to purchase multiple saddle pads of different styles and colors. Saddle pads can be expensive and specialized saddle pads may be even more expensive and difficult to find. Also, purchasing multiple lower-cost saddle pads may negatively affect the horse rider and the horse.

Additionally, in horse competitions and horse shows, it is important for the horse rider and horse to look their best. Over time, saddle pads can develop a worn look from use and the cost of replacing multiple saddle-pads can be cost prohibitive. A saddle pad with a worn look may negatively affect the overall appearance of the horse rider and horse. It can also be cost prohibitive to purchase a new saddle pad each time a saddle pad begins to develop a worn appearance.

In the past, some attempts have been made to address the challenges of quickly changing the appearance of a saddle pad for special equine events. Some horse riders have pinned fabric or other materials onto the top of their saddle pads in an attempt to match or coordinate the look of the saddle pad with their outfit. However, this method of changing the appearance of a saddle pad has some significant disadvantages. The pins used for securing the material to the saddle pad can come undone during performance and injure the horse. Pressure at the position of the pins may also create discomfort for the horse and distract the horse during performance, potentially decreasing the horse's level of performance. Thicker materials may also put pressure on the horse's back making the horse uncomfortable and decrease the horse's level of performance.

Some attempts have been made to address the challenges of quickly changing the appearance of saddle pads during equine events by placing a blanket between the saddle and the saddle pad. This method of changing the appearance of a saddle pad has some significant disadvantages. Blankets used to change the appearance of saddle pads commonly put pressure on the horses back, make the horse uncomfortable, and reduces the horse's range of motion which may lead to muscle atrophy over time. The discomfort can also distract the horse during performance thus decreasing the horse's level of performance. Another disadvantage to using blankets to change the appearance of a saddle pad is that the blankets can slip during performance because they are typically not secured to the saddle pad and are only held in place by the pressure between the saddle and the saddle pad.

In the past, covers for saddle pads have been developed to help reduce soiling and wear of saddle pads. However, saddle pad covers currently available are typically sleeve-type enclosures into which the saddle pad is inserted and completely enclosed and have some significant disadvantages. For example, the referenced saddle pad covers envelope the entire saddle pad so that the saddle pad does not lie directly on the horse and may interfere with the purpose of or impede or reduce the benefits of a saddle pad. Another disadvantage to saddle pad covers currently available is that it is time consuming to change them, because the saddle pad assembly must be removed entirely from the horse in order to change the saddle pad cover to insert the saddle pad into the sleeve-type covers. Time constraints during some equine events and competitions may make using such saddle pad covers challenging or impractical.

Thus, it is thus desirable to have an improved saddle pad cover assembly and method for changing the appearance of a saddle pad that allows the saddle pad to have direct contact with the horse's back, provides for quick and easy changeability of the saddle pad cover, and addresses other disadvantages discussed above.

### SUMMARY OF THE INVENTION

In accordance with one or more aspects of the present invention, a saddle pad cover assembly is provided wherein a saddle pad cover may be configured in a fitted shape for covering a top side of a saddle pad, wherein the saddle pad cover may be secured to the saddle pad by extending over a perimeter the saddle pad. In another aspect of the present invention, the saddle pad cover may include an opening for insertion of the saddle pad wherein the saddle pad cover may extend over the perimeter of the saddle pad and cover only a portion of an underside of the saddle pad while leaving a majority of an area of the underside of the saddle pad exposed for direct contact with a horse's back. In accordance with another aspect of the present invention, the saddle pad cover may be configured to permit the saddle pad to have direct contact with a horse's back when the saddle pad cover is secured to the saddle pad.

In another aspect of the present invention, the saddle pad cover assembly may include a saddle pad cover comprised of a stretchable fabric or material. The stretchable fabric or material of the saddle pad cover may be a four-way stretch material. The stretchable fabric or material of the saddle pad cover may also be a two-way stretch material. The four-way stretch and two-way stretch fabric or material provides size flexibility to that the size and shape of the saddle pad cover does not have to exactly replicate the size and shape of a saddle pad. In yet another aspect of the presentment, a perimeter of the opening of the saddle pad cover includes an elastic constriction band for securing the saddle pad cover to the saddle pad.

In another aspect of the present invention, the saddle pad cover assembly may include a saddle pad cover comprised of a lightweight fabric or material so as to minimize any increase in pressure that may be applied to a horse's back when the saddle pad cover and the saddle pad are configured as a saddle pad cover assembly and placed on a horse between the horse and the saddle. The fabric or material weight may be between about 2 oz. and 14 oz. per square yard. In a preferred embodiment, the weight of the fabric or material is in a range from about 4 oz. to about 6 oz. For lighter weight use, the weight of the fabric or material is preferably in a range from about 2 oz. to about 4 oz. For heavier light weight use, the weight of the fabric or material is in a range preferably from about 6 oz. to about 14 oz. Fabric weight as used herein is understood to be measured in ounces per square yard. For example, a 4 oz. weight material would be understood to be 4 ounces per square yard.

In another aspect of the present invention, the fabric or material comprising the saddle pad cover is breathable. Preferably, however, the fabric or material comprising the saddle pad cover is not sheer, although sheer fabrics or materials may be used in one or more embodiments of the present invention. As used here, sheer fabric or material is fabric or material which is made using thin thread and/or low density of knit and which results in a semi-transparent and flimsy cloth. The term fabric and material may be used interchangeably herein.

In yet another aspect of the present invention, a method is provided to easily and quickly change the appearance of a saddle pad, wherein two or more saddle pad covers are provided having different appearances and wherein one or more of the saddle pad covers are configured to permit easy assembly of the saddle pad cover with the saddle pad while the saddle pad is still on the horse's back.

The saddle pad cover assembly may include a saddle pad and a saddle pad cover disposed on the saddle pad so that the saddle pad cover conceals all or a substantial portion of a top side of the saddle pad to provide an alternate appearance to the top side of the saddle pad while permitting the saddle pad to be exposed on a bottom side for direct contact with a horse's back.

In another aspect of the present invention, a method is provided for matching or coordinating the saddle pad or saddle pad cover assembly color, style, look, design, or combination thereof with the color, style, look, or design of horse riding accessories or with the color of the horse, or a combination thereof.

In accordance with another aspect of the present invention, the saddle pad cover may comprise one or more sheets or panels configured as a fitted covering for a saddle pad. Elastics may be used for securing the cover opening around the edges of the saddle pad. Draw strings and other methods known to one skilled in the art may also be used for securing or fitting the perimeter of the cover opening around the edges of the saddle pad.

These and other aspects of the present invention are realized in a saddle pad cover and method for changing the appearance of a saddle pad as shown and described in the following figures and related description without placing limitations thereon.

### BRIEF DESCRIPTION OF THE DRAWINGS

Various embodiments of the present invention are shown and described in reference to the numbered drawings wherein:

FIG. 1a is a bottom view of a saddle pad cover in accordance with one or more aspects of the present invention;

FIG. 1b is a bottom view of a saddle pad cover comprised of a two-way stretch material in accordance with one or more aspects of the present invention;

FIG. 1c is a bottom view of a saddle pad cover comprised of a four-way stretch material in accordance with one or more aspects of the present invention;

FIG. 2 is a bottom view of a saddle pad cover assembly in accordance with one or more aspects of the present invention;

FIG. 3 is an exploded perspective view of a saddle pad assembly in position above a horse in accordance with one or more aspects of the present invention;

FIG. 4 is a perspective view of a saddle pad assembly disposed on a horse in accordance with one or more aspects of the present invention;

FIGS. 5a-5f show bottom views of a method of making a saddle pad cover in accordance with one or more aspects of the present invention;

FIGS. 6a-6d illustrate coordinating and matching of colors, styles, and designs of clothing and horse riding accessories with a saddle pad cover assembly of the present invention in accordance with one or more aspects of the present invention. FIGS. 6a-6d also illustrate the interchangeability of the color, style, look, or design of the saddle pad cover assembly of the present invention in order to coordinate or match with clothing or horse riding accessories or with the color of a horse in accordance with one or more aspects of the present invention;

FIGS. 6e-6h illustrate other horse riding accessories for which the color, style, look, or design of the saddle pad cover assembly may be matched or coordinated using the method of interchangeability of the saddle pad cover of the present invention in accordance with one or more aspects of the present invention; and

FIGS. 7a-7d show a top view of a method of configuring a saddle pad cover assembly of the present invention in accordance with one or more aspects of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION OF THE INVENTION

The invention and accompanying drawings will now be discussed so as to enable one skilled in the art to practice the present invention. The drawings and descriptions are exemplary of various aspects of the invention and are not intended to narrow the scope of the appended claims.

The present disclosure relates to a saddle pad cover assembly and method for quickly changing the appearance of a saddle pad. A saddle pad cover may be arranged on a saddle pad which is placed on a horse before placing and securing a saddle on the horse. The saddle pad cover may be arranged on the saddle pad so as to cover all or substantially all of a top side of the saddle pad while leaving a substantial area on a bottom side of the saddle pad uncovered permitting direct contact between the saddle pad and the horse. A plurality of saddle pad covers of various colors, styles, appearances, or designs may be provided and interchanged before or after use or between events. The saddle pad covers may be configured with colors, styles, appearances, or designs to coordinate with or match the clothing, outfit, or accessories of a horse rider of to coordinate with or match the color of the horse.

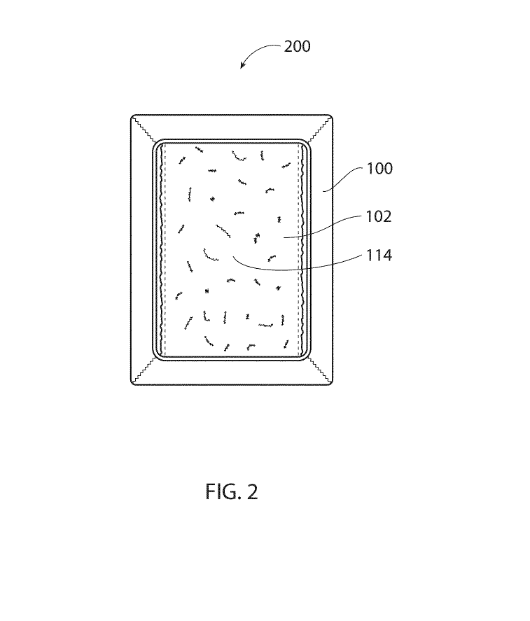

Referring now to FIG. 2, saddle pad cover assembly 200 in accordance with one or more aspects of the present invention is shown. As seen in FIG. 2, the saddle pad cover assembly 200 may be comprised of a saddle pad 102 wherein the saddle pad may be configured for use on a horse's back under a horse saddle and or configured for protecting the horse's back, and a saddle pad cover 100 configured in accordance with one or more aspects of the present invention. The saddle pad cover assembly 200 is configured so that a bottom area 114 of the saddle pad 102 remains uncovered by the saddle pad cover 100 so that a majority of the area on the underside 114 of the saddle pad 102 is capable of having direct contact with a horse's back when the saddle pad cover assembly 200 is in use. The saddle pad cover 100 may be secured to the saddle pad by extending the saddle pad cover 100 over a perimeter the saddle pad 102.

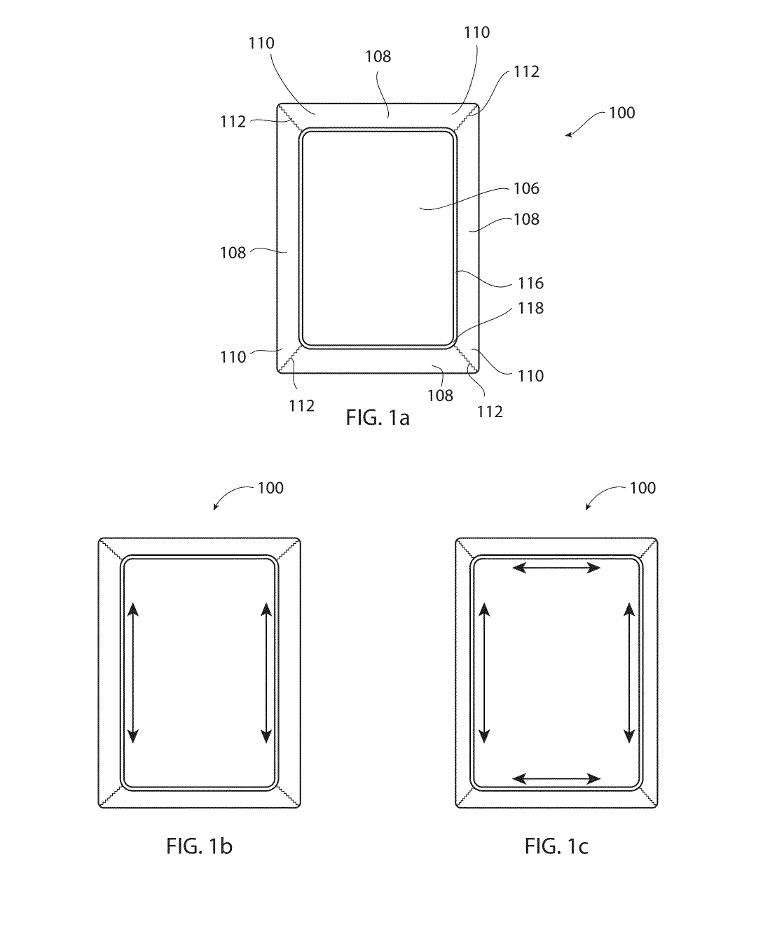

Referring now to FIG. 1a, a saddle pad cover 100 in accordance with one or more aspects of the present invention is shown. The saddle pad cover 100 may include an opening for insertion of the saddle pad 102 into the saddle pad cover 100 so that the saddle pad cover 100 extends over the perimeter of the saddle pad and covers a portion of an underside 114 of the saddle pad 102 while leaving a majority of an area of the underside 114 of the saddle pad 102 exposed for direct contact with a horse's back. When the saddle pad assembly 200 is assembled and properly configured on a horse, the saddle pad cover 100 is secured on the saddle pad 102 so that the underside of the saddle pad 102 has direct contact with the horse's back.

Referring now to FIGS. 1b-1c, a saddle pad cover 100 comprised of a stretch material in accordance with one or more aspects of a preferred embodiment of the present invention is shown. As shown in FIG. 1c, the saddle pad cover 100 may be comprised of a four-way stretch material. As shown in FIG. 1b, the saddle pad cover 100 may be comprised of a two-way stretch material. The four-way and two-way stretch material provides size flexibility to that the size and shape of the saddle pad cover 100 does not have to exactly replicate the size and shape of a saddle pad. As shown in FIG. 1a, a perimeter of the opening of the saddle pad cover 100 may include an elastic constriction band to help secure the saddle pad 100 cover to the saddle pad 102.

The saddle pad cover 100 may be constructed of one or more materials including spandex, Lycra® knits, elastane, or other polyester-polyurethane copolymer knits or elastic fabrics. The saddle pad cover 100 may be constructed of various fabrics that stretch and conform to the saddle pad 102 underneath. The saddle pad cover may also be made of various nylon, polyester, rayon, or cotton knits. The saddle pad cover 100 may be machine-washable. The saddle pad cover 100 may be wrinkle resistant when stored in a small container, allowing for storability in a tack room or horse trailer.

The saddle pad cover 100 of the saddle pad cover assembly 200 may also be comprised of a lightweight material to minimize pressure that is applied to a horse's back when the saddle pad cover assembly 200 is configured on a horse between the horse and the saddle. The material weight may be between about 2 oz. and 14 oz. per square yard. In a preferred embodiment, a preferred material weight may range from about 4 oz. to about 6 oz. because material in this weight range generally has good durability for special event use without excessive thickness, which can put undue pressure on a horse's back or limit a horse's mobility. For events where a lighter material is appropriate, a preferred material weight may range from about 2 oz. to about 4 oz. For uses where a heavier light-weight material is appropriate, a preferred material weight may range from about 6 oz. to about 14 oz. Fabric weight as used herein is understood to be measured in ounces per square yard. For example, a 4 oz. weight material would be understood to be 4 ounces per square yard.

In another aspect of the present invention, the material comprising the saddle pad cover 100 is breathable. While transparent or semi-transparent materials may be used, they are not usually preferred because they often lack durability although they may be used where the saddle pad cover 100 is not expected to be used for a significant number of events.

In a preferred embodiment, the saddle pad cover 100 may be about 38 inches by about 40 inches in pre-construction size. The saddle pad cover 100 may be adapted to resist slippage between the saddle and the saddle pad 102. The saddle pad cover 100 may further be adapted to resist wear in locations exposed to rubbing and abrasion.

The saddle pad cover 100 may be fitted to substantially match or conform to the shape of the saddle pad 102. Saddle pad covers 100 in accordance with one or more aspects of the present invention may be manufactured to fit a wide variety of types of saddle pads, including any one or combination of Western saddle pads, barrel racing saddle pads, saddle pads with rounded edges, English saddle pads, gel saddle pads, wool saddle pads, neoprene saddle pads, custom saddle pads, dressage pads, sheepskin saddle pads, full pads, square pads, shaped pads, half pads, and riser pads.

As shown in FIG. 1a, the saddle pad cover 100 may be dimensioned for a tight fit over the saddle pad cover 102. The saddle pad cover may include a top panel 106, retaining flaps 108, and corner pockets 110 formed by connecting the adjacent ends of the retaining flaps 108 at a connection seam or juncture 112. The top panel 106 and the retaining flaps 108 may be comprised if a single continuous piece of material or fabric or may be made of independent pieces of material stitched together or secured together by other means known to those skilled in the art. The top panel 106 and retaining flaps 108 may also form one large pocket into which a saddle pad 102 may be inserted when the saddle pad cover 100 is assembled.

The adjacent ends of the retaining flaps 108 may be connected at the connection seam or juncture 112 by sewing the adjacent ends of the retaining flaps 108 at an angle. Excess material at the connection seam or juncture 112 may be removed by excising or cutting it from the saddle pad cover 100 without cutting or removing stiches or other fastening means used for connecting adjacent ends of the retaining flaps 108. The corners (not shown) of the saddle pad 102 may be inserted or received into the corner pockets 110 of the saddle pad cover 100. The retaining flaps 108 may lie substantially flat against a bottom surface 114 of the saddle pad. The edge of the retaining flaps may form a hem 116 around the perimeter of the opening of the saddle pad cover 100, wherein the opening may be used for insertion of the saddle pad 102. The hem 116 may be a continuous hem 116 or a plurality of hems may be disposed around the perimeter of the opening of the saddle pad cover 100. One or more fastening or tightening mechanisms 118 may be attached to the hem 116.

The one or more fastening or tightening mechanisms 118 may be one or more elastic constriction bands made from apparel elastic. In a preferred embodiment, the apparel elastic is one/fourth-inch apparel elastic. The one or more fastening or tightening mechanisms 118 may be one or more elastic constriction bands sewn secured around the perimeter or at least a portion of the perimeter of the opening of the saddle pad cover 100. The one or more elastic construction bands may be disposed within the hem 116 of the saddle pad cover 100 and configured to pucker the material so that the saddle pad cover 100 is form fitting to a saddle pad 102 with corner pockets 110 in all four corners to hold the saddle pad cover 100 in place. In one embodiment, the one or more fastening or tightening mechanisms 118 may comprise four elastic constriction bands, wherein each elastic constriction band is connected to the hem 116 proximate to a connection seam or juncture 112. The one or more fastening or tightening mechanism 118 may also be a drawstring or other mechanism known to one skilled in the art.

In one or more embodiments, the one or more fastening or tightening mechanisms 118 may comprise one substantially continuous elastic constriction band connected to or disposed within the hem 116. In another embodiment, the one or more fastening or tightening mechanisms 118 may comprise at least one of a snap, a button, a zipper, a hook and a loop mechanism, or temporary glue. In an embodiment, the one or more fastening or tightening mechanisms 118 may comprise at least one of an elastic constriction band, a drawstring, a tie string, and elastic material. Alternatively, the saddle pad cover 100 may be fitted without having one or more fastening or tightening mechanisms 118.

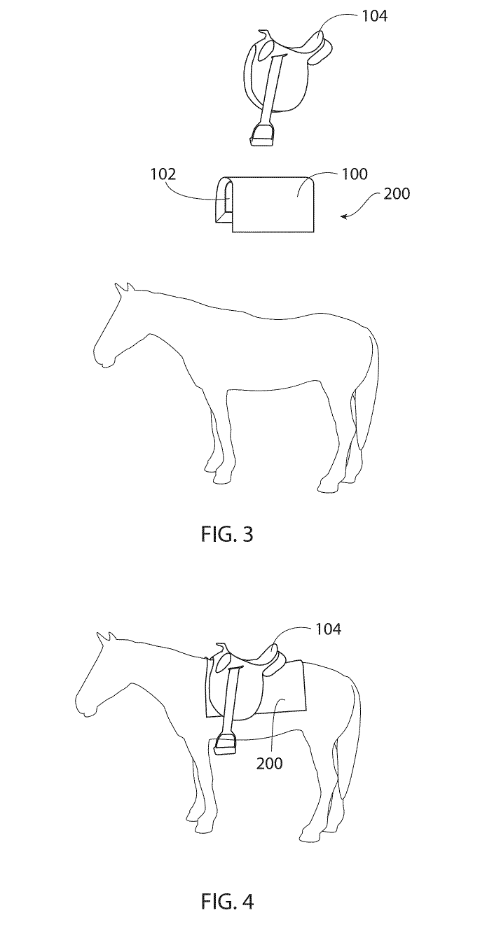

Referring now to FIGS. 3 and 4, a saddle pad cover assembly 200 is shown in conjunction with a horse and a saddle 104. As shown in the Figures, the saddle pad 102 is disposed within the saddle pad cover 100 so that a top side of the saddle pad 102 is covered by the top panel 106 of the saddle pad cover 100 and so that at least a portion of the underside of the saddle pad 102 is not covered by the saddle pad cover 100. In a preferred embodiment, at least of the underside of the saddle pad 102 is not covered by the saddle pad cover. As shown in the Figures, the top side of the saddle pad cover 100 is disposed between the saddle pad 102 and the saddle 104. When the saddle pad cover assembly 200 is configured with the saddle 104 on the horse, a substantial portion of the saddle pad 102 may be in direct contact with the horse.

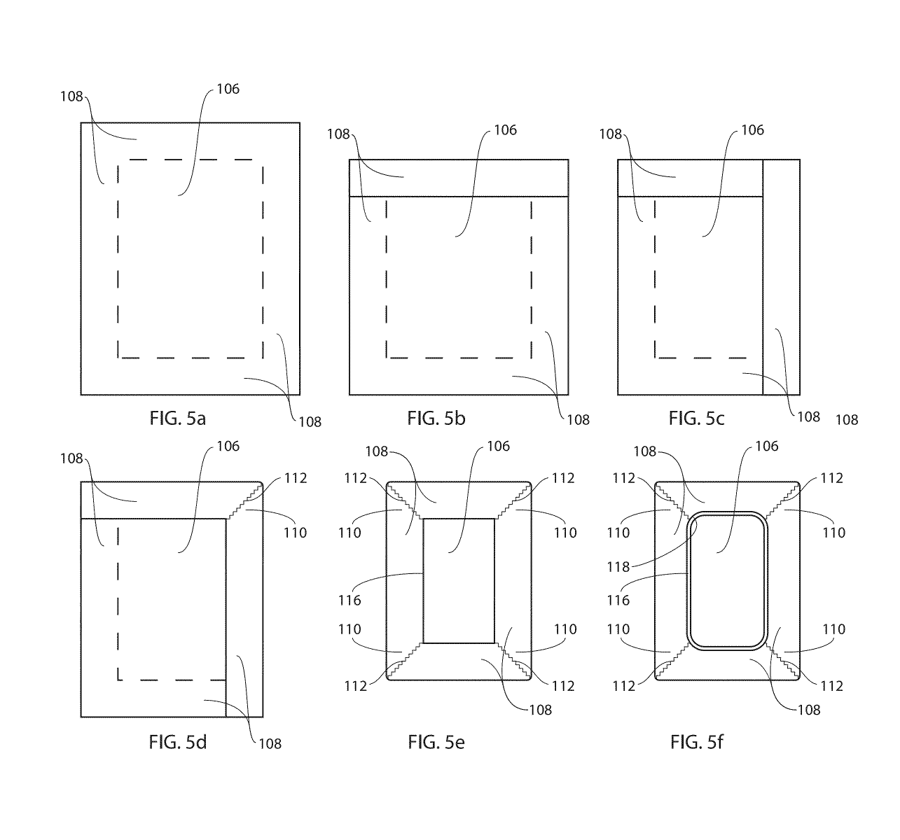

Referring now to FIGS. 5a-5f, a method of making of a saddle pad cover in accordance with one or more aspects of the present invention is illustrated. The dotted lines are for illustrative purposes only to show the difference between the top panel 106 and the retaining flaps 108. Referring now to FIG. 5a, the material to make the saddle pad cover 100 may comprise a top panel 106 and retaining flaps 108. Referring now to FIG. 5b, a first retaining flap 108 is folded inward. Referring now to FIG. 5c, a second retaining flap 108 is folded inward. Referring now to FIG. 5d, a pocket 110 is formed by the connection 112 of adjacent edges of the retaining flaps 108. The connection 112 may comprise sewing the adjacent ends of the retaining flaps 108 at an angle. Cuts may be to material of adjacent ends of the retaining flaps 108 to remove excess material or to improve sewing angles for sewing connection seams or junctures 112 and or to improve the fit of the corner pockets 110 of the saddle pad cover 100. Referring now to FIG. 5e, the remaining retaining flaps 108 are folded and the remaining corner pockets 110 are formed by the connections 112 of adjacent edges of the retaining flaps 108. As in FIG. 5d, cuts may be to material of adjacent ends of the retaining flaps 108 at each of the corners to remove excess material or to improve sewing angles for sewing connection seams or junctures 112 and or to improve the fit of the corner pockets 110 of the saddle pad cover 100.

A hem 116 may also be sewn at the outer edge of the retaining flaps 108 to reduce fraying at the edge of the material or for insertion of apparel elastic or other elastic constriction band.

Referring now to FIG. 5f, one or more fastening or tightening mechanisms 118 may be attached to or disposed within the hem 116. In one embodiment, excess material may be removed from the adjacent edges of the retaining flaps 108 prior to connection 112 of adjacent edges of the retaining flaps 108. In another embodiment, excess material may be removed from the adjacent edges of the retaining flaps 108 after connection 112 of adjacent edges of the retaining flaps 108.

An advantage of the saddle pad cover assembly 200 of the present invention is that the saddle pad cover 100 may be secured to the saddle pad 102 without interfering with the horse's performance, or with minimal interference with the horse, and without interfering with the purpose of the saddle pad 102 when the saddle pad cover assembly 200 is configured with a saddle on a horse. Another advantage of the saddle pad cover assembly 200 of the present invention is that it permits a horse rider or performer to quickly and inexpensively change the appearance of the saddle pad 102 without removing the saddle pad 102 entirely from the horse. This may be accomplished while maintaining the above discussed advantages and other advantages of the present invention by removing from the saddle pad 102 a saddle pad cover 100 of the present invention having one appearance and exchanging it for another saddle pad cover 100 of the present invention having a different appearance that is then secured to the saddle pad 102 in accordance with the present invention.

In another embodiment of the present invention, a method for changing the appearance of a saddle pad 102 is provided. In yet another embodiment of the present invention, a method for coordinating the appearance of the saddle pad cover assembly with the appearance of a horse or of horse riding accessories and or apparel is provided.

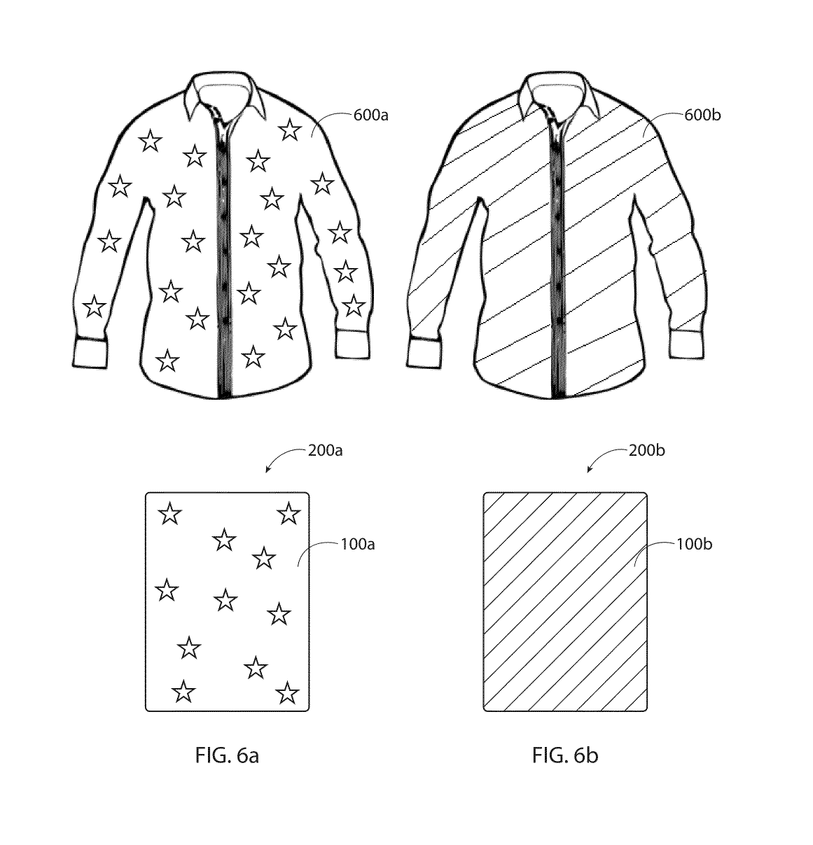

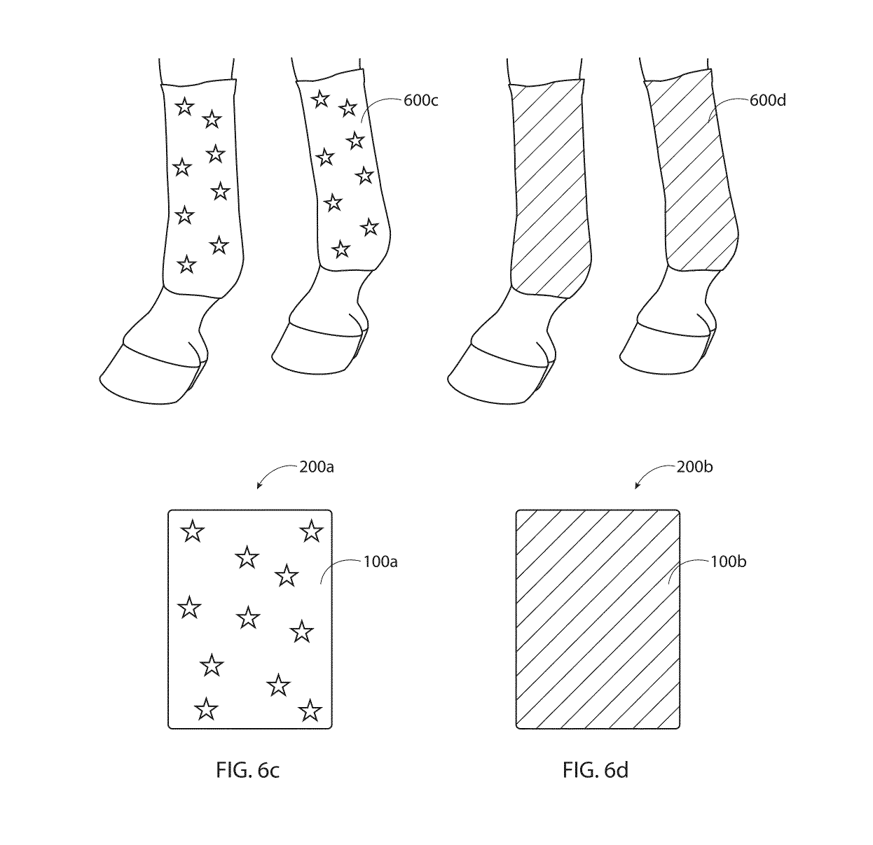

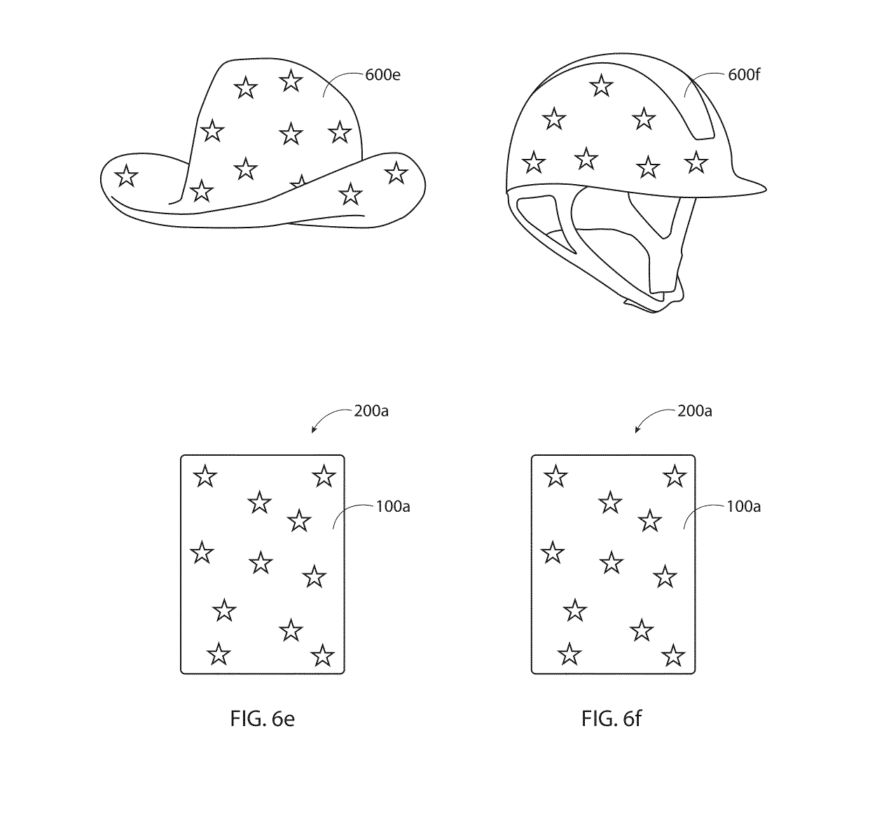

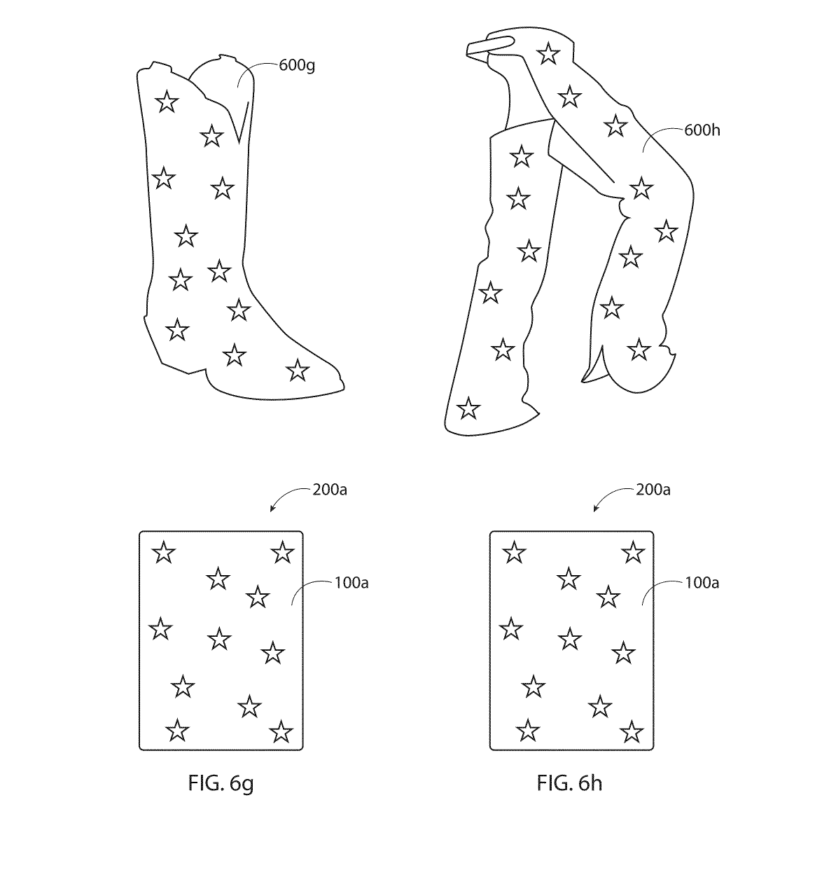

Referring now to FIGS. 6a-6h, a method of coordinating the appearance of a saddle pad cover assembly 200 with horse riding apparel or accessories using a saddle pad cover 100 of the present invention is shown. As can be seen in FIGS. 6a-6d, a saddle pad cover assembly 200 may be configured with a saddle pad cover 100 of the present invention having an appearance, colors, pattern, style, or design that matches or coordinates with horse riding apparel or accessories or with the color of a horse. Accessories and or apparel that may be coordinated or matched with the saddle pad cover assembly 200 may include saddles, bridles, decorations, horse leg wraps, medicine boots, splints boots, polo wraps, shirts, tops, jackets, vests, pants, chaps, boots, hats, helmets, belts and buckles, hairs bows, ribbons, and earrings. It will be appreciated that other apparel or accessories known in the industry for use in horse riding events and shows could be used in conjunction with the saddle pad cover assembly 200 of the present invention without departing from the scope of the invention.

As shown in FIGS. 6a-6b and FIGS. 6c-6d, a plurality of saddle pad covers 100a, 100b having different appearances, such as differences in color, pattern, design, or style may be used for configuring saddle pad cover assemblies 200a, 200b having different appearances in accordance with one or more aspects of the present invention. A single saddle pad 102 may be used to configure various saddle pad assemblies 200a, 200b before, during, after, or between events to coordinate with different apparel or accessories, such as various decorative riding shirts 600a, 600b or various decorative horse leg wraps 600c, 600d having different appearances and which may also be traded or changed before, after, during, or between events.

FIGS. 6a and 6b illustrate interchanging a saddle pad cover 100a with another saddle pad cover 100b to reconfigure a saddle pad cover assembly 200a to another saddle pad cover assembly 200b to have a different appearance to coordinate with different decorative riding shirts 600a, 600b. A second saddle pad cover 100b may have a different appearance than a first saddle pad cover 100a. The different appearance of each saddle pad cover 100 may permit coordinating or matching the saddle pad cover 100 with clothing or outfit of a horse rider or the theme of the event. The different appearance of each saddle pad cover may include one or more of colors, patterns, designs, materials, and styles.

As shown in FIGS. 6a-6b, the star pattern of saddle pad cover 100a and the star pattern of the shirt 600a substantially match whereas the striped pattern of saddle pad cover 100b and the striped pattern of shirt 600b substantially match. The saddle pad cover 100 may conceal all or a substantial portion of a top surface 120 of the saddle pad 102 to provide an alternate appearance to the top side of the saddle pad 102 while permitting the saddle pad 102 to be substantially exposed on a bottom surface 114 for direct contact with a back of a horse. The saddle pad covers 100 may be easily and quickly exchanged to change the appearance of the saddle pad cover assembly to match or coordinate with apparel and accessories as need during special events.

FIGS. 6c-6d illustrate the ability to change the appearance of the saddle pad cover assembly 200a, 200b to match or coordinate with other accessories such as horse leg wraps 600c, 600d having different appearances. FIGS. 6e-6h show other examples of horse riding accessories and apparel with which the different saddle pad cover assemblies of the present invention may be matched or coordinated, such as a hat 600e, a riding helmet 600f, boots 600g, or chaps 600h.

Reconfiguring a saddle pad cover assembly 200 to change its appearance by interchanging saddle pad covers 100 having different appearances may include removing a saddle pad cover 100a from the saddle pad 102 and replacing it with a saddle pad cover 100b having a different appearance.

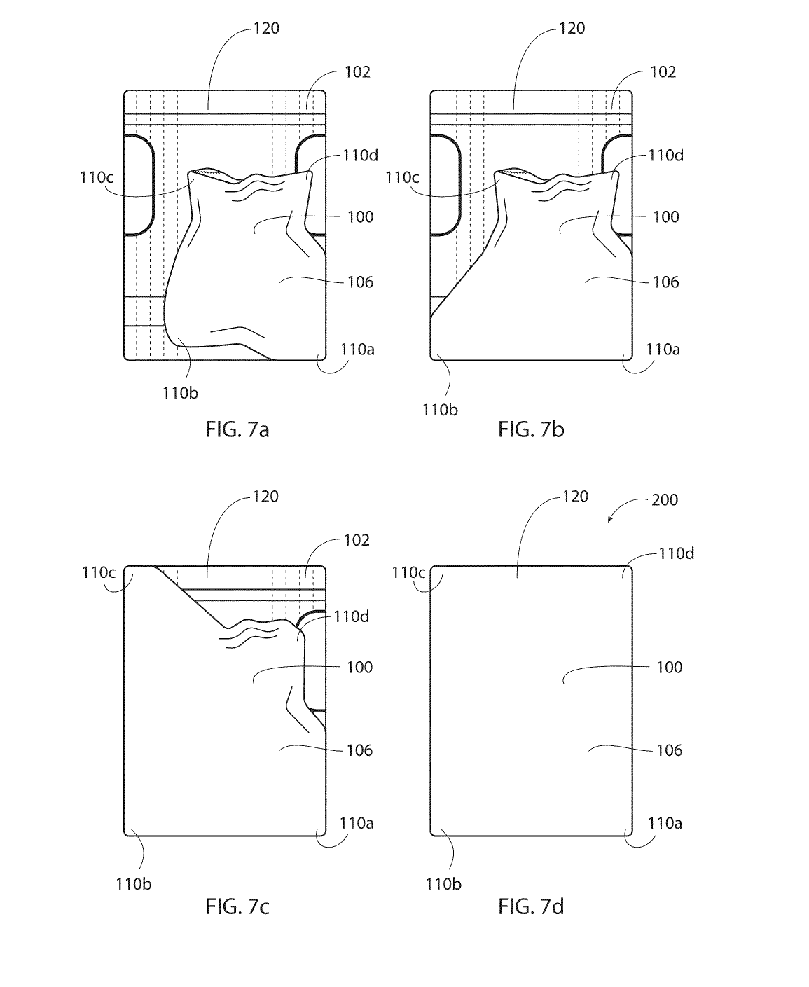

Referring now to FIGS. 7a-7d, a top view of a method of configuring a saddle pad cover assembly 200 of the present invention in accordance with one or more aspects of the present invention is shown. The top panel 106 of the saddle pad cover 100 may be configured to cover a top surface 120 of the saddle pad 102 by extending the saddle pad cover 100 over the perimeter of the saddle pad 102. Referring now to FIG. 7a, a first corner (not shown) of the saddle pad 102 is inserted into a first pocket 110a of a saddle pad cover 100. Referring now to FIG. 7b, a second corner (not shown) of the saddle pad 102 is inserted into a second pocket 110b of a saddle pad cover 100. Referring now to FIG. 7c, a third corner (not shown) of the saddle pad 102 is inserted into a third pocket 110c of a saddle pad cover 100. Referring now to FIG. 7d, a fourth corner (not shown) of the saddle pad 102 is inserted into a fourth pocket 110d of a saddle pad cover 100 so that the top surface 120 of the saddle pad 102 or a major portion of the top surface 120 of the saddle pad is covered by the top panel 106 of the saddle pad cover 100. The retaining flaps 108 (not shown) are projected underneath and lie substantially flat against a bottom surface 114 (not shown) of the saddle pad 102 and around a perimeter of the underside of the saddle pad 102. The saddle pad cover 100 may extend over the perimeter of the saddle pad 102 and cover only a portion of an underside of the saddle pad 102 around the perimeter of the underside of the saddle pad 102 while leaving a majority of an area of the underside of the saddle pad 102 uncovered by the saddle pad cover 100 to permit direct contact by the underside of the saddle pad 102 with a horse's back.

There is thus disclosed an improved saddle pad cover and saddle pad cover assembly, a method for changing the appearance of a saddle pad, and a method for coordinating the appearance of a saddle pad or saddle pad cover assembly with the riding apparel and accessories and with a horse's color. It will be appreciated that numerous changes may be made to the present invention without departing from the scope of the claims.

With respect to the above description, it is to be realized that the optimum dimensional relationships for the parts of an embodiment enabled by the disclosure to include variations in size, materials, shape, form, function, and manner of operation assembly and use, are deemed readily apparent and obvious to one skilled in the art, and all equivalent relationships to those illustrated in the drawings and described in the specification are intended to be encompassed by an embodiment of the disclosure. For example, the above description may be applied to a non-rectangular saddle pad cover.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modification and equivalents may be resorted to, falling within the scope of the disclosure.

What is claimed is:

1. A saddle pad cover assembly comprising:
a saddle pad configured for use between a saddle and a horse;
a saddle pad cover comprising a top panel for covering a top portion of the saddle pad, wherein the top panel is configured to be located between the saddle pad and a saddle;
wherein one or more retaining flaps are disposed around a perimeter of the top panel of the saddle pad cover and extend over a perimeter of the saddle pad and are disposed substantially flat against at least a portion of a perimeter of a bottom surface of the saddle pad; and
wherein the saddle pad and the saddle pad cover are configured so that a majority of the area defining the bottom surface of the saddle pad is not covered by the saddle pad cover so as to permit direct contact between the bottom surface of the saddle pad and the back of a horse when disposed on a horse.

2. The saddle pad cover assembly of claim 1, wherein the saddle pad cover has an opening for insertion and removal of the saddle pad, the opening being defined by a perimeter formed by an edge of the one or more retaining flaps.

3. The saddle pad cover assembly of claim 2, wherein the saddle pad cover further comprises a hem extending along at least a portion of the perimeter formed by the edge of the one or more retaining flaps.

4. The saddle pad cover assembly of claim 3, wherein at least one fastening mechanism is disposed adjacent to the hem for securing the saddle pad cover to the saddle pad.

5. The saddle pad cover assembly of claim 4, wherein the fastening mechanism is selected from the group consisting of a snap, a button, a zipper, a hook and a loop fastener, and temporary glue.

6. The saddle pad cover assembly of claim 3, wherein at least one tightening mechanism is disposed to the hem, wherein the tightening mechanism is selected from the group consisting of an elastic constriction band, a drawstring, a tie string, and elastic material.

7. The saddle pad cover assembly of claim 6, wherein the one or more retaining flaps comprises four retaining flaps connected at seams between adjacent ends of each of the four retaining flaps, wherein the at least one tightening mechanism comprises four elastic constriction bands, wherein each of the four elastic constriction bands is disposed on the saddle pad cover adjacent to the hem at one of the seams between the adjacent ends of the four retaining flaps.

8. The saddle pad cover assembly of claim 6, wherein the at least one tightening mechanism comprises an elastic constriction band disposed adjacent to the hem along the perimeter formed by the edge of the one or more retaining flaps.

9. The saddle pad cover assembly of claim 1, wherein the saddle pad cover is comprised of a stretch material wherein the stretch material is selected from the group consisting of spandex, Lycra®, and elastane.

10. The saddle pad cover assembly of claim 1, wherein the saddle pad cover is made of a fabric having a fabric weight within the range of about 4 oz. per square yard and about 6 oz. per square yard.

11. A saddle pad cover assembly comprising:
a saddle pad cover having a top panel side for covering a top side of a saddle pad, one or more retaining flaps disposed coterminous with a perimeter of the top panel side of the saddle pad cover for securing a saddle pad, the retaining flaps having an edge defining a perimeter of an opening in the saddle pad cover for inserting a saddle pad;
wherein the retaining flaps are configured to extend over a perimeter of a saddle pad and cover at least a portion of a perimeter of an underside of a saddle pad while leaving a majority of an area of the underside of a saddle pad exposed to permit direct contact by the saddle pad with a horse's back; and
wherein the saddle pad cover is made of lightweight stretch material.

12. The saddle pad cover assembly of claim 11, wherein the lightweight stretch material comprises a four-way stretch material.

13. The saddle pad cover assembly of claim 11, wherein the lightweight stretch material comprises a two-way stretch material.

14. The saddle pad cover assembly of claim 11, wherein the lightweight stretch material is selected from the group consisting of spandex, Lycra®, and elastane.

15. The saddle pad cover assembly of claim 11, wherein the lightweight stretch material has a fabric weight within the range of about 2 oz. per square yard to about 14 oz. per square yard.

16. The saddle pad cover assembly of claim 11, wherein the lightweight stretch material has a fabric weight within the range of about 4 oz. per square yard to about 6 oz. per square yard.

17. A method of changing the appearance of a saddle pad cover assembly, comprising:
selecting a saddle pad cover assembly comprising a saddle pad configured for use between a saddle and a horse; a first saddle pad cover comprising a top panel for covering a top portion of the saddle pad, wherein the top panel is configured to be located between the saddle pad and a saddle; wherein one or more retaining flaps are disposed around a perimeter of the top panel of the first saddle pad cover and extend over a perimeter of the saddle pad and are disposed substantially flat against at least a portion of a perimeter of a bottom surface of the saddle pad;
removing the first saddle pad cover from the saddle pad;
selecting a second saddle pad cover wherein the second saddle pad cover comprises a top panel for covering a top portion of the saddle pad, wherein the top panel is configured to be located between the saddle pad and a saddle; wherein one or more retaining flaps of the second saddle pad cover are disposed around a perimeter of the top panel of the second saddle pad cover and are configured for extending over a perimeter of the saddle pad and are configured for being disposed substantially flat against at least a portion of a perimeter of a bottom surface of the saddle pad;
wherein an outer appearance of the second saddle pad cover is different from an outer appearance of the first saddle pad cover;
inserting the saddle pad into a an opening of the second saddle pad cover, the opening being defined by a perimeter formed by an edge of the one or more retaining flaps of the second saddle pad; and
extending the one or more retaining flaps of the second saddle bad cover over a perimeter of the saddle pad; and
configure the saddle pad and the second saddle pad cover so that a majority of the area defining the bottom surface of the saddle pad is not covered by the saddle pad cover so as to permit direct contact between the bottom surface of the saddle pad and the back of a horse when the saddle pad assembly is disposed on a horse.

18. The method of claim 17, further comprising
selecting one or more horse riding accessories wherein the one or more horse riding accessories match the outer appearance of the second saddle pad cover; and
using the one or more horse riding accessories within visible proximity of the matching second saddle pad cover.

19. The method of claim 18, wherein the one or more horse riding accessories is selected from the group consisting of a saddle, a bridle, horse leg wraps, medicine boots, splints boots, polo wraps, a shirt, a top, a jacket, a vest, pants, chaps, boots, a hat, a helmet, a belt, a belt buckle, hairs bows, a ribbons, and earrings.

20. The method of claim 17, wherein the first saddle pad cover and the second saddle pad cover are comprised of a stretchable fabric having a fabric weight in the range of about 2 oz. per square yard to about 14 oz. per square yard.
